(19) United States
(12) Patent Application Publication
(10) Pub. No.: US 2012/0244516 A1
(43) Pub. Date: Sep. 27, 2012

(54) Interactive Graphic

(75) Inventors: Lisa Pertzborn-Whiting, Waunakee, WI (US); Doug Crews Nelson, (US); Steven Young, Waunakee, WI (US)

(73) Assignee: Imagination Trends, LLC, a Wisconsin limited liability company, DeForest, WI (US)

(21) Appl. No.: 13/340,297

(22) Filed: Dec. 29, 2011

Related U.S. Application Data
(60) Provisional application No. 61/428,726, filed on Dec. 30, 2010.

(51) Int. Cl. A63G 31/00; G09B 19/00

(52) U.S. Cl. 434/428; 472/57

(57) ABSTRACT

An interactive graphic is disclosed. The interactive graphic is includes a background graphic capable of being attached to a surface and movable pieces that cling to and glide on the background graphic.

### PRIORITY CLAIM/CROSS-REFERENCE TO RELATED APPLICATIONS

This application claims priority from U.S. Provisional Patent Application No. 61/428,726, filed on Dec. 30, 2010, which is incorporated herein by reference for all purposes.

### FIELD OF THE INVENTION

The present invention relates generally to the field of consumer products. More particularly, the present invention relates to interactive scene displays for use in toy, education, art and craft, decorative, and game applications.

### BACKGROUND

Interactive scene displays have multiple uses, for example, as toys, educational devices, and for arts and crafts, just to name a few. Colorforms® toys are one of the oldest examples of interactive scene displays. Colorforms® toys are cardboard cut-out scenes with die-cut vinyl figures that stick to the cardboard cut-out scene using static cling. These figures can then be removed and reapplied to create new scenarios. Other similar products include sticker books and magnets.

There are three primary problems with current products in this category. The first involves the adhesive component of the figures with the scene. The figures do not slide to new positions with ease. Instead they must be completely removed from the background and reapplied to new positions. This makes the product less child-friendly and also leads to ripping and tearing. Stickers are even less versatile and child-friendly as they are typically not meant to be removed.

The second problem is the limited versatility of the current products and technologies. Colorforms® toys, for example, are not meant to adhere to any surface. Likewise, magnets can only adhere to magnetic surfaces and stickers cannot be easily removed from most surfaces.

The third problem has to do with the various environmental and health implications of the current products and technology, for example, if they contain chemicals such as phthalates. Phthalates are commonly used as plasticizers to soften polyvinyl chloride, which is a material that can be used in interactive scene displays, but phthalates are suspected of causing or contributing to numerous health problems due to endocrine disruption and therefore products without phthalates are preferred.

As such there is a need for an interactive scene display that addresses one or more of these shortcomings. It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiments, and will be readily apparent to those skilled in the art. Such objects, features, benefits and advantages will be apparent from the above as taken in conjunction with the accompanying figures and all reasonable inferences to be drawn therefrom.

### SUMMARY OF THE INVENTION

An interactive graphic includes a background substrate, a background image printed on the background substrate, and one or more moveable pieces. The moveable pieces are attachable to the background substrate using static cling and are glidable on the background substrate. The static cling of the moveable pieces is rechargeable.

Many embodiments of an interactive graphic exist. For example in one embodiment of a children's toy, the interactive graphic includes a background substrate having an adhesive for attaching the background substrate to a surface, a background image printed on the background substrate, and one or more moveable pieces, where the background image and image printed on the one or more moveable pieces are related. The moveable pieces are attachable to the background substrate using static cling and are glidable on the background substrate. The static cling of the moveable pieces is rechargeable.

In another embodiment of an educational device, the interactive graphic includes a background substrate having an adhesive for attaching the background substrate to a surface, a background image printed on the background substrate, and one or more moveable pieces, where the background image and image printed on the one or more moveable pieces are related to an educational theme. The moveable pieces are attachable to the background substrate using static cling, and are glidable on the background substrate. The static cling of the moveable pieces is rechargeable.

### BRIEF DESCRIPTION OF THE DRAWINGS

FIG. 1 is a front perspective view of a background graphic in accordance with the present invention.

FIG. 2 is a front perspective view of an interactive graphic in accordance with the present invention, showing moveable pieces applied to the background graphic of FIG. 1.

FIG. 3 is a front perspective view of some of the movable pieces from FIG. 2, without the background graphic.

FIG. 4 is a perspective view of a background graphic in accordance with the invention, showing the background graphic being removed from its liner.

FIG. 5 is a front perspective view of moveable pieces on a liner in accordance with the present invention, and showing one of the moveable pieces being removed from the liner.

FIG. 6 is an exploded view of moveable pieces for a doll design for an interactive graphic in accordance with the present invention.

### DETAILED DESCRIPTION

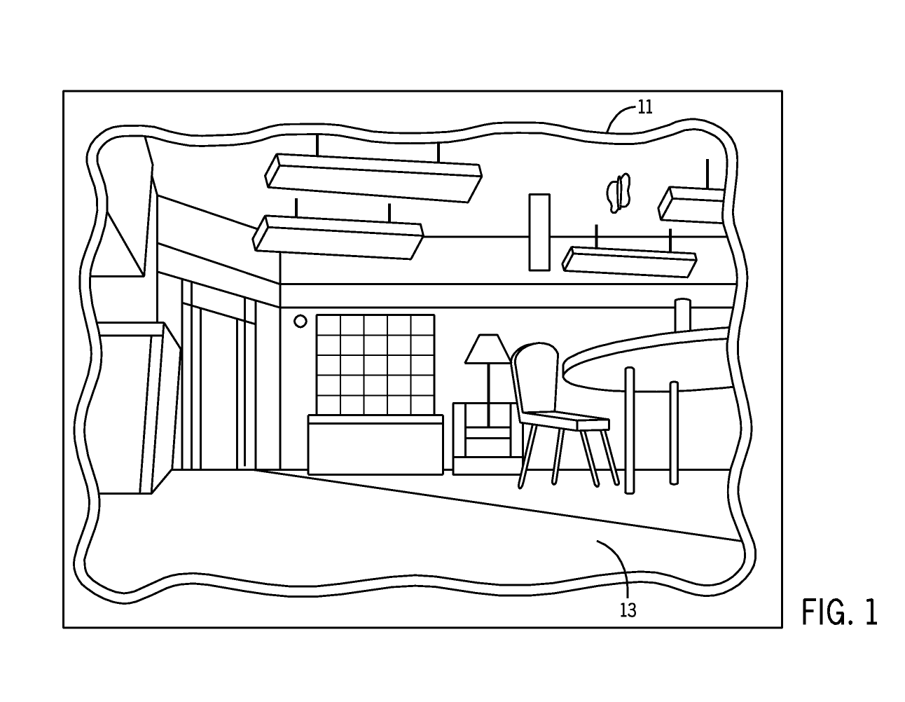

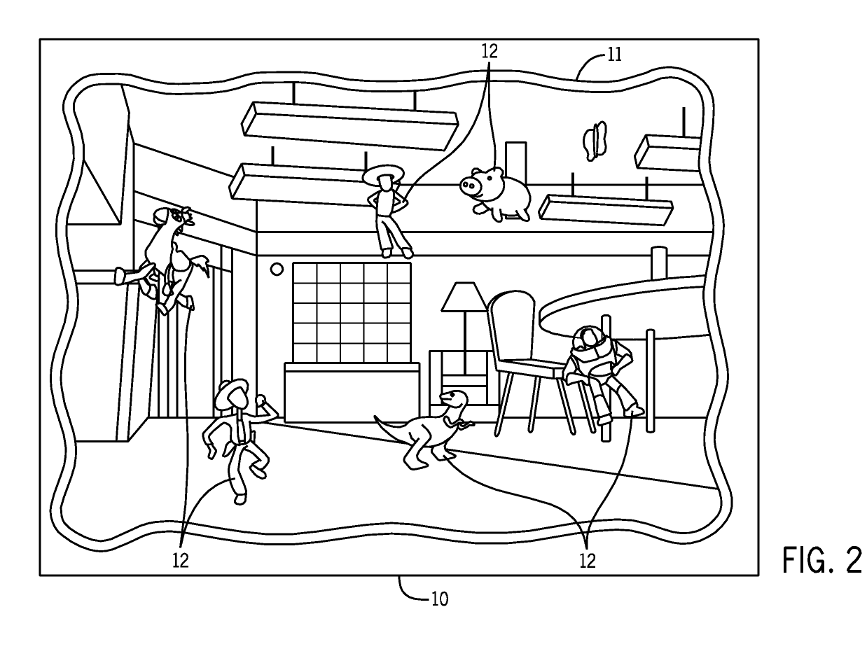

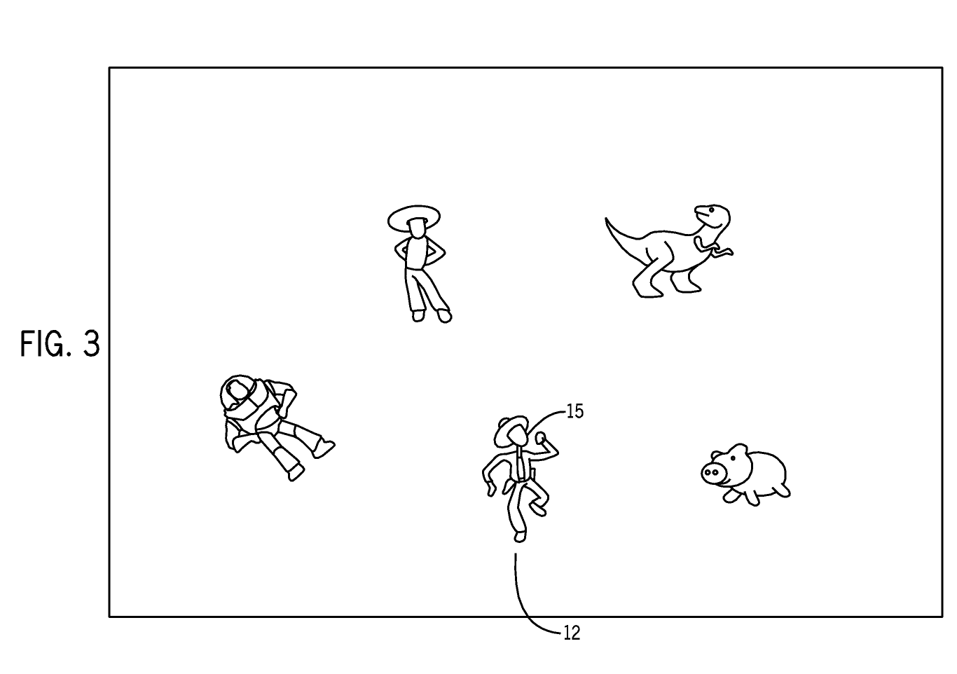

An interactive graphic 10 has a background graphic 11, and moveable pieces 12. See, e.g. FIGS. 1-3. Moveable pieces 12 cling to the background graphic 11 or surrounding surfaces, such as a wall or table, using static electricity. The background graphic 11 can comprise a background image 13 printed on a background substrate 14. Alternatively, background substrate 14 may be plain.

Background substrate 14 for background graphic 11 can be any material suitable for serving as a base to which one or more moveable pieces 12 can be applied. A variety of materials can be used for the background substrate 14, including for example, adhesive-backed polyester or polyolefin, corrugated plastics (such as Coroplast®), paper, the material used for moveable pieces 12, or even one or more moveable pieces 12 themselves. Background substrate 14 and any printing or coatings applied to it should contain little or no volatile organic compounds (VOCs). VOCs will counteract the electrostatic charge of moveable pieces 12 and interfere with the effectiveness of moveable pieces to cling to the background substrate 14. Thus, products containing vinyl, which emit VOCs, are less desirable materials for background substrate 14 because they will tend to reduce the charge of the movable pieces.

One substrate that is particularly well-suited for use as a background substrate 14 is the IJ86E Wall Decorating Film made by 3M, which is a thin, 6.5-7 millimeter, polyolefin film with a pressure-activated adhesive on the back. This adhesive is activated when the user applies pressure but is also removable so that the user may remove, and reuse the product. It leaves little or no adhesive residue after removal.

Traditional poster paper, for example, 100 lb. gloss text, can also be used for a background substrate 14. Poster paper emits no VOCs and creates the appropriate environment for the movable pieces 12 to cling. Because traditional poster material does not come with an adhesive backing, an adhesive may be applied. For example, one adhesive product that may be used is a product called Gudy 804 and is manufactured by Neschen, which is a 3 millimeter vinyl carrier with an aggressive permanent adhesive on one side and a low tack removable adhesive on the other. If the Gudy 804 adhesive is used, the permanent side can be placed against the back of the printed background image, and the low tack side will face outward so the consumer can place it against the wall when they use it, but then remove it if desired. Although these are two examples of background substrates 14 that can be used for the background graphic 11, almost any smooth flat substance could be used for the background substrate 14.

The substance from which movable pieces 12 are made, or one or more moveable pieces themselves, may also be used as the material for background substrate 14, as it allows like material to be placed on it while maintaining its ability to cling to the surface on which it is placed.

Any type of image, picture, scene, or design may be used for the background image 13. Images may be plain or detailed, and could be black and white or colored. Some example images and embodiments are discussed in further detail below, but others can be readily created. Ink coverage on background substrate 14 for background image 13 should be minimized to provide the most desirable surface on which to place and glide movable pieces 12.

The moveable pieces 12 are pieces that cling to the background graphic 11 or surrounding surfaces, such as a wall or table, using static electricity. To create moveable pieces 12, an image 15 is (or images are) printed on a moveable substrate 16. The image 15 used for the moveable pieces 12 could be any image capable of being printed on the moveable substrate 16; such images 15 could be plain or detailed, color or black and white, and could relate to each other and/or to the background image 13. While a variety of moveable substrates 16 could be used, a preferred moveable substrate is ClingZ® Indigo, a 2 millimeter polypropylene with a 10 millimeter liner, which is made by ClingZ, Inc., and can cling to almost any clean, dry surfaces without leaving any residue. These properties enable users of an interactive graphic 10 to interact the moveable pieces 12 with the background graphic 11, by gliding the moveable pieces 12 on surface of the background graphic 11. Over time, the moveable pieces lose their charge, but they are easily recharged. To recharge the moveable pieces 12 the user only needs to rub the pieces against carpeting, cotton clothing or anything else that will create a static charge. If made from the materials described herein, both the background graphic 11 and moveable pieces 12 are made of recyclable material and are phthalate free.

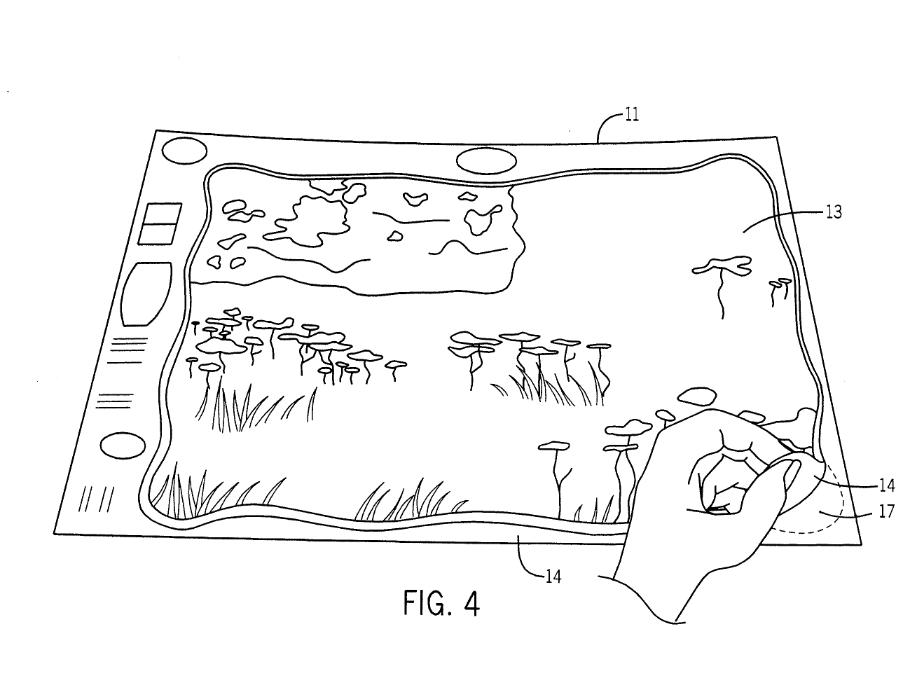

Background image 13 may be printed on background substrate 14 using a UV curing, high definition print (HDP) inkjet printer which emits minimal amounts of VOCs. As shown in FIG. 4, if the background image 13 is printed on a background substrate 14 such as the IJ86E, the background graphic is printed while the background substrate is positioned on a liner 17, which serves to secure the material for printing, and can also be used for storage. Once printed, the background graphic 11 is die cut and/or kiss cut allowing it to be removed from the background liner 17 by the user. If the background graphic 11 is printed on a traditional poster material, a high/low tack adhesive can be applied to the back with the stronger, high tack side pressed against the back of the poster, and the low tack adhesive facing outward with a protective backing for the user to remove when they are ready to use it.

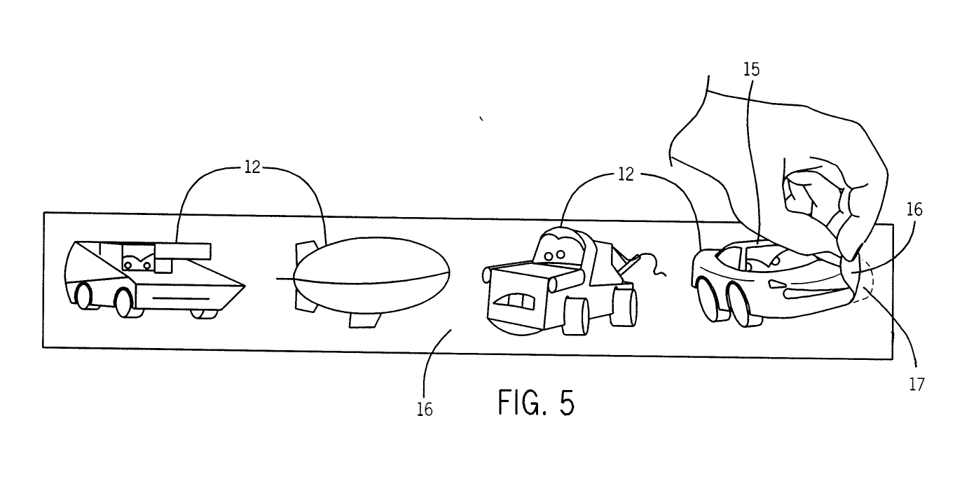

The process used to print the image 15 on moveable substrate 16 is a digital offset printing process. It is a waterless offset system with UV curing designed to maintain the integrity of the moveable substrate, which is not able to withstand the high heat of other curing processes. As shown in FIG. 5, the individual moveable pieces 12 are printed on a the moveable substrate 16, which is also usually on a liner 17. The moveable pieces 12 are then die cut on the liner in the desired shapes and sizes. As shown in FIG. 5, when the interactive graphic 10 is ready to be used, the user peels the moveable pieces 12 and the background graphic 11 off of their respective liners. When not in use, the background graphic 11 can be rolled-up with the moveable pieces 12 and placed in retail packaging or otherwise stored. Retail packaging for the interactive graphic 10 may be made from a polyester copolymer, with minor additives such as stabilizers and catalysts that are not released with normal use.

For best results, the printing process used for the components of interactive graphic 10 should use as little ink as possible because less ink allows more electrostatic charge to be used in attaching moveable pieces 12 to background graphic 11. For example, using a CMYK (cyan, magenta, yellow, black) 4-color process uses less ink than if using Pantone colors. CMYK 4-color process is also less dense and adds less weight to the printed moveable pieces. Excess ink, or other coatings such a varnish or aqueous coatings may also cause the substrate materials to curl. Alcohols and VOCs should also be avoided during the printing process because these compounds tend to cause the moveable substrate 16 to lose its charge. Measures should be taken to off-gas any printed components of the interactive graphic 10, as well as any printed product inserts or packaging components, to release alcohols or VOC before combining with moveable pieces 12. Off-gassing refers to allowing the printed materials to sit for an amount of time in open air after being printed, in order to allow the natural evaporation of VOCs and other compounds to occur. For example, the inventors typically off-gas printed materials for a minimum of 36 hours before combining them with moveable pieces 12. Further, if additional ornamental features are added to moveable pieces 12, such as glitter or glow-in-the-dark features, best results will be achieved by keeping these features, or at least the weight of these features, to a minimum so as to not add excess weight to the moveable pieces 12. Excess weight can reduce the ability of moveable pieces 12 to cling to the background graphic 11. If additional ornamental features are added to moveable pieces 12, such pieces should be air dried rather than dried using heat to minimize substances that may interfere with the electrostatic charge of moveable pieces 12.

The user of an interactive graphic 10 can apply the background graphic 11 to any smooth, clean surface, such as a table or a wall. If the background graphic 11 is on a liner, the user removes it from the liner and adheres it to the surface by pressing it against the surface and smoothing it over. If the background graphic 11 is not on a liner, but for example is on a traditional poster material with an adhesive such as a double-sided tape, the user removes the background graphic 11 from the double-sided tape and presses the background graphic 11 against the wall applying pressure where the tape is located. The movable pieces 12 are then pressed against the background graphic 11 or surrounding surface, such as a wall or table, and can repositioned by sliding them across the surfaces. After a period of time, the moveable pieces 12 will lose their static charge. To recharge the pieces the user simply needs to rub the pieces against the background graphic, a piece of clothing, carpeting, or anything else that creates a small static charge.

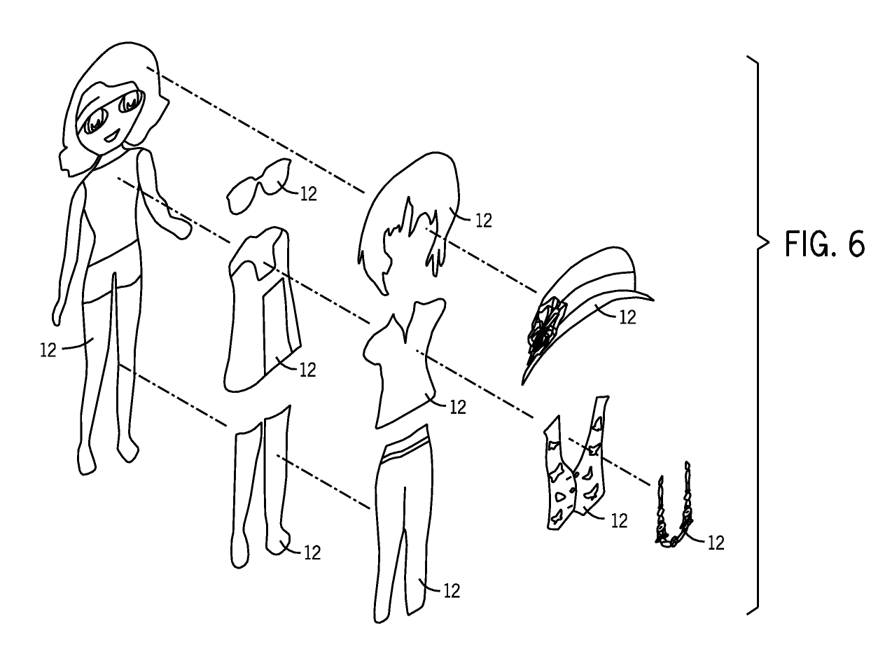

There are a multitude of different embodiments of the interactive graphic 10 that provide many different uses, for example arts and crafts, education, toys, decorative, and games. One example of an embodiment of an interactive graphic 10 used as a toy is shown in FIGS. 1-3, where the background image 13 is an image from a popular movie, and the moveable pieces 12 are the characters from the movie. In another game or toy example, the background image 13 could depict a doll house, and the moveable pieces 12 could represent paper dolls and clothing and accessories for the dolls, for example as shown in FIG. 6. Story-telling could be incorporated as well. For example, the background graphic 11 may depict a setting for a children's story and the moveable pieces 12 could be objects or characters involved in the story that can be moved to depict scenes in the story. In yet another game embodiment, the background graphic 11 could serve as the board piece placed on a vertical surface, rather than a flat horizontal surface, while the movable pieces 12 would serve as the interactive game pieces. When used as a decorative piece, the product may consist of both the background graphic 11 and movable pieces 12 being used as a part of a theme or color scheme.

In additional educational embodiments of interactive graphic 10, users can interact with movable pieces 12 and the background graphic 11 actively participating in the learning process. An interactive graphic 10 may be used by educators for subjects including, but not limited to, math, science, geography and health. A few examples of possible educational designs are maps with important geographic features and landmarks, a scene that explains different weather events and seasons, a grocery store scene that teaches both health and counting money, and a classroom scene that could incorporate math. For example, the background graphic 11 could be a map of the United States of America, and the movable pieces 12 would be state capitals, where the user learns by placing the movable pieces 12 onto the appropriate sections of the background graphic 11 map. Certain properties of the background substrate 14 or moveable substrates 16 can also enhance the educational value of the interactive graphic 10. For example, materials used for the background graphic 11 or moveable pieces 12 may have dry erase capabilities, which allows the user, whether it is a teacher, parent, or student to write on the material and erase them when finished. This property could be used in educational embodiments and settings to write sentences, math problems, or pictures onto the background graphic 11 or moveable pieces 12 and then erase them when they are finished.

In arts and crafts related embodiments of an interactive graphic 10, a variety of different customizable craft options that can be applied to either the moveable pieces 12 or the background graphic 11, or both, to create a completely customizable unique product. For example, moveable pieces 12 and/or background graphic 11 could be printed and ready for immediate use, or they could be partially printed or unprinted and customizable using a variety of craft options. There are certain markers, crayons and other products that will decrease or remove the electrostatic charge in the moveable pieces 12. But it has been discovered that 3.3 lead based colored pencils for example can be used on the moveable pieces 12 without removing their charge. This enables a user to draw on or decorate the various components of the interactive graphic 10. For example as part of a paper doll set, blank necklaces and hats could be included, such as those shown in FIG. 6, so that children can draw their own design and then add them to the dolls. Other possible additions include extra design elements such as, glitter, glow in the dark materials, and fragrant inks that give the product certain distinct odors. While adding to the overall product design, these additional options also add an extra level of interactivity and customization. These extra craft components are additional options and will not necessarily be included with every product design.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A children's toy comprising:
a background substrate having an adhesive for attaching the background substrate to a surface;
a background image printed on the background substrate;
one or more moveable pieces comprising a moveable substrate on which an image is printed, the moveable pieces attachable to the background substrate using static cling and glidable on the background substrate, the static cling of the moveable substrate being rechargeable; and
wherein the background image and image printed on the one or more moveable pieces are related.

2. The children's toy of claim 1 wherein the background image is a scene from a movie or television program and the images on the one or more moveable pieces are characters from the movie or television program.

3. The children's toy of claim 1 wherein the background image depicts a setting for a story and the images on the one or more moveable pieces are objects or characters involved in the story.

4. The children's toy of claim 1 wherein the background image includes a depiction of one or more character or doll, and wherein the one or more moveable pieces comprise clothing or accessories for characters or dolls depicted by the background image.

5. The children's toy of claim 1 wherein the one or more moveable pieces comprise at least one character or doll and wherein the one or more moveable pieces further comprise clothing or accessories for the character or doll.

6. The children's toy of claim 1 wherein the background image comprises a game board and the one or more moveable pieces comprise interactive game pieces.

7. The children's toy of claim 1 wherein the children's toy functions as a decorative piece, the background image and the one or more moveable pieces related by a theme or color scheme.

8. An educational device comprising:
a background substrate having an adhesive for attaching the background substrate to a surface;
a background image printed on the background substrate;
one or more moveable pieces comprising a moveable substrate on which an image is printed, the moveable pieces attachable to the background substrate using static cling and glidable on the background substrate, the static cling of the moveable substrate being rechargeable; and
wherein the background image and image printed on the one or more moveable pieces are related to an educational theme.

9. The educational device of claim 8 wherein the background substrate has dry erase properties such that a user of the educational device can temporarily mark the background substrate with dry erase markers.

10. The educational device of claim 8 wherein the background image comprises a map and the one or more moveable pieces comprise geographic locations or markers on the map.

11. An interactive graphic comprising:
a background substrate;
a background image printed on the background substrate; and
one or more moveable pieces comprising a moveable substrate on which an image is printed, the moveable pieces attachable to the background substrate using static cling and glidable on the background substrate, the static cling of the moveable substrate being rechargeable.

12. The interactive graphic of claim 11 wherein the moveable substrate is printed using a digital offset printing process that maintains the integrity and static cling of the moveable substrate.

13. The interactive graphic of claim 11 wherein the background substrate is the same material used for the one or more moveable pieces.

14. The interactive graphic of claim 11 wherein the background image on the background substrate is decoratable using art or craft materials.

15. The interactive graphic of claim 11 wherein the image on the one or more moveable pieces is decoratable using art or craft materials.

16. The interactive graphic of claim 11 wherein the one or more moveable pieces includes glitter.

17. The interactive graphic of claim 11 wherein one or more of the moveable pieces glow-in-the-dark.

18. The interactive graphic of claim 11 wherein the one or more moveable pieces are scented.
